(19) United States
(12) Patent Application Publication
(10) Pub. No.: US 2020/0101576 A1
(43) Pub. Date: Apr. 2, 2020

(54) PLATEN ASSEMBLY AND METHOD OF ASSEMBLING A PLATEN ASSEMBLY

(71) Applicant: Applied Materials, Inc., Santa Clara, CA (US)

(72) Inventors: Jay GURUSAMY, Santa Clara, CA (US); David J. LISCHKA, Austin, TX (US); Steven M. ZUNIGA, Soquel, CA (US)

(21) Appl. No.: 16/534,765

(22) Filed: Aug. 7, 2019

Related U.S. Application Data
(60) Provisional application No. 62/738,879, filed on Sep. 28, 2018.

(51) Int. Cl. B24B 37/12; B24B 37/20

(52) U.S. Cl. CPC B24B 37/12; B08B 1/007; B24B 37/20

(57) ABSTRACT

A method and apparatus for a separable assembly in a platen assembly is provided. The two components of the separable assembly couple together through the first coupling member and the second coupling member, and the coupling is magnetic. The web assembly and hub assembly are placed or decoupled via the methods as described above. The separable components of the assembly reduce the cost and time of removing the entire platen assembly from the CMP system when maintenance or repair is to be performed.

### CROSS-REFERENCE TO RELATED APPLICATIONS

This application claims priority to U.S. Provisional Patent Application No. 62/738,879, filed Sep. 28, 2018, which is hereby incorporated by reference in its entirety.

### BACKGROUND

### Field

Embodiments of the invention relate to an apparatus and a method and, more specifically, to a platen assembly and a method of assembling a platen assembly.

### Description of the Related Art

Chemical mechanical polishing (CMP) is a conventional process used in many different industries to planarize surfaces of substrates. In the semiconductor industry, uniformity of polishing and planarization has become increasingly important as device feature sizes continue to decrease. During a CMP process, a substrate, such as a silicon wafer, is mounted on a carrier head with the device surface placed against a moving polishing pad. The carrier head provides a controllable load on the substrate to push the device surface of the substrate against the polishing pad. A polishing liquid, such as a slurry containing fine abrasive particles in a chemical agent designed to react with the substrate to be polished, is supplied to the surface of the moving polishing pad and carrier head. The polishing slurry is typically supplied to the polishing pad to provide an abrasive chemical solution at the interface between the polishing pad and the substrate.

A recurring problem in CMP is non-uniformity of the polishing rate across the surface of the substrate. Additionally, conventional polishing pads generally deteriorate naturally during polishing due to wear and/or accumulation of polishing by-products on the pad surface. During repeated or continuous polishing a conventional polishing pad becomes worn or “glazed” after polishing a certain number of substrates, and then needs to be replaced or reconditioned. Glazing occurs when the conventional polishing pad is heated and compressed in regions where the substrate is pressed against the pad.

In addition, hardware components that are exposed to polishing liquid are attacked by the slurry components and chemical agents, which will affect the usable lifetime of these hardware components. Due to structural complexity created by the polishing system processing requirements, it is often hard in conventional polishing tool designs to prevent the interaction of the polishing liquid from coming in contact with and attacking the supporting hardware components, such as supporting platen hardware components, roll-to-roll polishing pad actuators, and roll-to-roll polishing pad guides. Therefore, continuous and frequent repair of pads and hardware components is necessary.

One drawback of the CMP in the art is the labor and cost to remove and repair the components of the polishing system and/or remove and replace a conventional polishing pads and roll-to-roll pads disposed over a platen after the polishing pad has become worn from extended use. The polishing system involves a large amount of removable and expensive parts, including the platen to hold the pad, the assembly to support the platen, actuators to position the roll-to-roll pad over the platen, and/or another actuator to rotate the assembly and provide polishing to the substrate.

Therefore, there is a need for a platen assembly that is easy to disassemble for cleaning and repair, while still protecting the components within the assembly from the outside environment.

### SUMMARY

In one embodiment, a coupling apparatus is provided, including a first coupling member having a first coupling surface, wherein the first coupling surface is disposed a distance from a first surface of a wall, a second coupling member having a second coupling surface, wherein the second coupling surface is disposed a distance from a second surface of the wall and the second surface is on an opposite side of the wall from the first surface, and a first spindle that is configured to support a length of a polishing pad material and is coupled to the second coupling member. The second coupling member allows a rotational motion imparted to the second coupling member from the first coupling member to cause a second rotational motion of the first spindle.

In another embodiment, a platen assembly is provided, including a wall, a hub assembly, and a web assembly. The hub assembly includes a first coupling member having a first coupling surface, wherein the first coupling surface is disposed a distance from a first surface of the wall, and a first actuator coupled to the first coupling member. The web assembly is positioned on the hub assembly. The web assembly includes a pad supporting surface, a second coupling member having a second coupling surface, wherein the second coupling surface is disposed a distance from a second surface of the wall and the second surface is on an opposite side of the wall from the first surface, and a first spindle that is coupled to the second coupling member, wherein the second coupling member allows a rotational motion imparted to the second coupling member from the first coupling member to cause a first rotational motion of the first spindle. The first spindle is configured to support a portion of a polishing pad.

In yet another embodiment, a method of assembling a platen assembly is provided, including placing a web assembly on a hub assembly. The web assembly includes a pad supporting surface, a second coupling member having a second coupling surface, wherein the second coupling surface is disposed a distance from a wall, and a first spindle that is configured to support a length of a polishing pad material and is coupled to the second coupling member. The hub assembly includes a first coupling member having a first coupling surface, wherein the first coupling surface is disposed a distance from a first surface of the wall, and a first actuator coupled to the first coupling member. The second coupling surface is on an opposite side of the wall from the first surface. The first coupling member and the second coupling member are coupled together through the wall. The second coupling member allows a rotational motion imparted to the second coupling member from the first coupling member to cause a first rotational motion of the first spindle. The first spindle is configured to rotationally support a roll of pad material.

The web assembly and the hub assembly are separable pieces of the polishing system. The assemblies couple together through the first coupling member and the second coupling member, and the coupling is magnetic. The separable pieces allow only a portion of the polishing system to be dissembled, which reduces time and labor cost for maintenance and servicing of the polishing system. The magnetic coupling also removes breakable mechanical pieces from the seal of the assemblies, and protects the components inside the assembly from the chemical environment.

### BRIEF DESCRIPTION OF THE DRAWINGS

So that the manner in which the above-recited features of the present disclosure can be understood in detail, a more particular description of the embodiments, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A illustrates a plan view of a chemical mechanical polishing system configured to polish substrates, according to one embodiment.

FIG. 1B illustrates a schematic isometric view of a platen assembly of the polishing system of FIG. 1A, according to one embodiment.

FIG. 2 illustrates an exploded isometric view of the platen assembly of FIG. 1B, according to one embodiment.

FIG. 3A illustrates a bottom view of the platen assembly of FIG. 1B, according to one embodiment.

FIG. 3B illustrates a close-up bottom view of the platen assembly of FIG. 1B, according to one embodiment.

FIG. 4 is a flow chart of method operations for placing a web assembly on a hub assembly, according to one embodiment.

FIG. 5 is a flow chart of method operations for decoupling a web assembly from a hub assembly, according to one embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the disclosure provided herein include a platen assembly that includes separable hardware assemblies that are used in a polishing module. In general, the platen assembly includes a web assembly and a hub assembly that are disposed within a portion of the polishing module. In some embodiments, portions of the web assembly and the hub assembly are physically isolated from each other, but are coupled together through the use of a coupling assembly. Embodiments of the disclosure provided herein also provide a method to position the web assembly on the hub assembly or remove the web assembly from the hub assembly. In other embodiments, only the web assembly is placed on or removed from the hub assembly and/or the platen assembly. Embodiments of the disclosure provided herein may be especially useful for, but are not limited to, forming a seal between two separable components of a platen assembly.

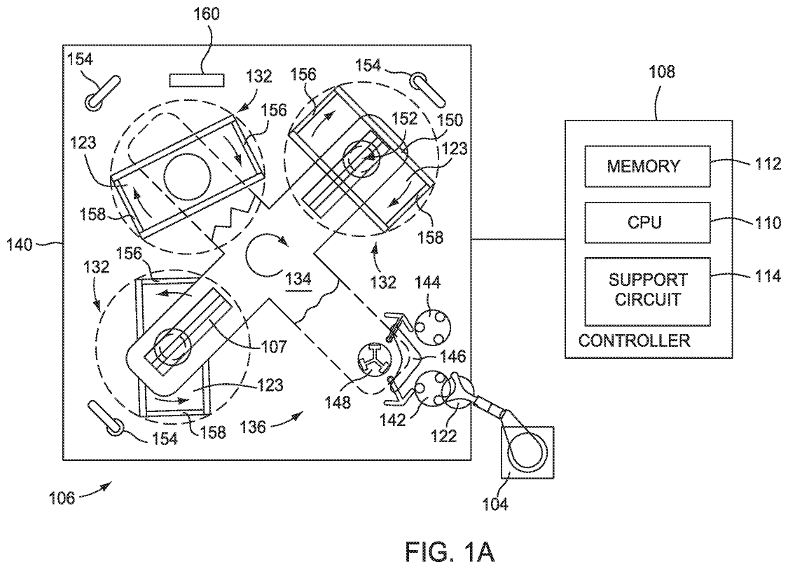

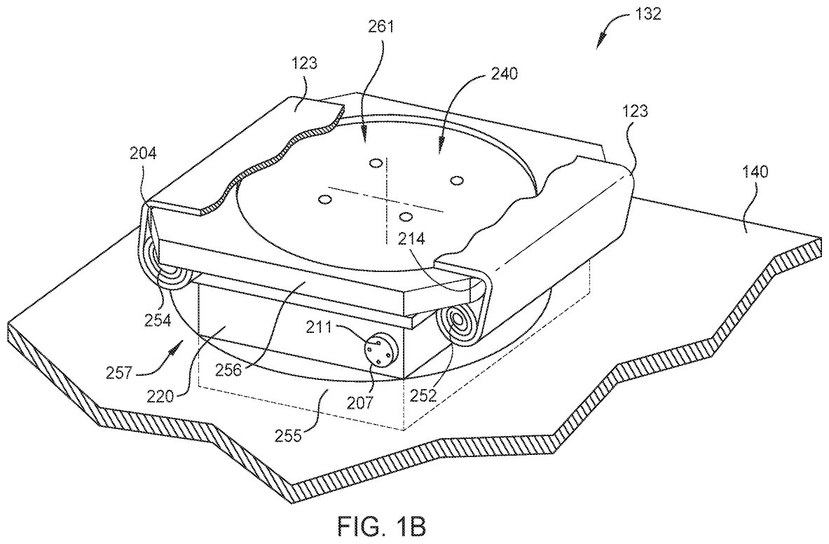

FIG. 1A illustrates a plan view of a chemical mechanical polishing system 106 configured to polish substrates, according to one embodiment. The polishing system 106 can be a portion of a REFLEXION® Chemical Mechanical Polisher, such as the REFLEXION® WEBB™ system, the REFLEXION® LK CMP system, and/or the REFLEXION® LK PRIME™ CMP system, all of which are manufactured by Applied Materials, Inc., located in Santa Clara, Calif. One or more of the implementations described herein can be used on these polishing systems. However, one skilled in the art can advantageously adapt implementations as taught and described herein to be employed on other types of polishing devices produced by other manufacturers that utilize polishing articles, and particularly polishing articles in a roll-to-roll or round polishing article format. The apparatus description described herein is illustrative and should not be construed or interpreted as limiting the scope of the implementations described herein.

As shown, the polishing system 106 includes a controller 108, a transfer station 136, a plurality of platen assemblies 132, a base 140, and a carousel 134. The base 140 supports the plurality of platen assemblies 132, the carousel 134, and the transfer station 136. The carousel 134 supports a plurality of polishing or carrier heads 152 (only one is shown in FIG. 1A). The transfer station 136 moves substrate 122 from outside the polishing system 106 into the polishing system. The carousel 134 transports the substrate 122 from the transfer station 136 to the first platen assembly 132, and from the first platen assembly to the remaining platen assemblies. The controller 108 provides the recipe for the time spent at each platen assembly 132, which platen assemblies to stop at, and so on. The substrate 122 can be polished at each platen assembly 132 sequentially, or the substrate 122 can be polished only at a select number of platen assemblies 132, depending on the information sent by the controller 108. The platen assemblies 132 can be embedded in the base 140, such that a portion of the platen assembly is below the surface of the base. The polishing system 106 moves the substrate 122 to and from the plurality of platen assemblies 132, and delivers the substrate back to the factory interface.

As shown, the transfer station 136 includes a transfer robot 146, an input buffer station 142, an output buffer 144, a loading robot 104, and a load cup assembly 148. The input buffer station 142 receives a substrate 122 from the loading robot 104. Generally, the loading robot 104 is disposed proximate the polishing system 106 and a factory interface (not shown) to facilitate the transfer of substrates 122 therebetween. The transfer robot 146 moves the substrate 122 from the input buffer station 142 to the load cup assembly 148 where the substrate 122 can be transferred to the carrier head 152. The transfer station 136 moves the substrate 122 to and from the polishing system 106.

As shown, the controller 108 includes a central processing unit (CPU) 110, support circuits 114 and memory 112. The CPU 110 can be one of any form of computer processor that can be used in an industrial setting for controlling various polishers, drives, robots and sub-processors. The non-volatile memory 112 is coupled to the CPU 110. The memory 112 can be one or more of readily available memory, such as random access memory (RAM), read only memory (ROM), floppy disk, hard disk, or any other form of digital storage, local or remote. The support circuits 114 are coupled to the CPU 110 for supporting the processor in a conventional manner. These circuits include cache, power supplies, clock circuits, input/output circuitry, subsystems, and the like. The controller 108 can include the central processing unit (CPU) 110 that is coupled to input/output (I/O) devices found in the support circuits 114 and the non-volatile memory 112. The non-volatile memory 112 can include one or more software applications, such as a controlling software program. The memory 112 can also include stored media data that is used by the CPU 110 to perform one or more of the methods described herein. The CPU 110 can be a hardware unit or combination of hardware units capable of executing software applications and processing data. In some configurations, the CPU 110 includes a central processing unit (CPU), a digital signal processor (DSP), an application-specific integrated circuit (ASIC), and/or a combination of such units. The CPU 110 is generally configured to execute the one or more software applications and process the stored media data, which can be each included within the memory 112. The controller 108 also controls how many platen assemblies 132 the substrate 122 receives polishing from, and how long the substrate stays at each platen assembly. The controller 108 controls the machinery of the polishing system 106, moving the substrate 122 to and from the polishing system 106, and moving the substrate around the plurality of platen assemblies 132.

As shown, the carousel 134 includes a plurality of arms 150, a plurality of carrier heads 152, and a track 107. The plurality of arms 150 each includes a carrier head 152. The carrier heads 152 are movable along the arm 150 via the track 107. Two of the arms 150 depicted in FIG. 1A are shown in phantom such that the transfer station 136 and the polishing pad 123 disposed on or over one of the platen assemblies 132 can be seen. The carousel 134 is indexable, such that the carrier heads 152 can be moved between the platen assembly 132 and the transfer station 136. In another implementation, the carousel 134 is replaced by a circular track and the carrier heads 152 are movable along the circular track. Typically, a CMP process is performed at each platen assembly 132 by moving the substrate 122 retained in the carrier head 152 relative to the polishing pad 123 supported on the platen assembly 132. The carousel 134 moves the substrate 122 to and from the plurality of platen assemblies 132.

FIG. 1B illustrates a schematic isometric view of a configuration of the platen assembly 132 of the polishing system 106 of FIG. 1A, according to one embodiment. As shown, the platen assembly 132 includes a polishing pad 123, coupling apparatus 257, wall 220, hub assembly 255, and web assembly 256. The polishing pad 123 is positioned across portions of a pad supporting surface 240 of the platen assembly 132, and configured to be advanced by the supply assembly 156 and the take-up assembly 158, according to one embodiment. The supply assembly 156 and the take-up assembly 158 can provide an opposing bias to polishing pad 123 in order to tighten and/or stretch an exposed portion of the polishing pad disposed therebetween. In some embodiments, the polishing pad 123 is a roll of pad material, delivered across the pad supporting surface 240 by use of a first spindle 252 and a second spindle 254 in the supply assembly 156 and take-up assembly 158, respectively. The polishing pad 123 can generally have a flat or planar surface topology when stretched between the supply assembly 156 and the take-up assembly 158. Additionally, the polishing pad 123 can be advanced across and/or be releasably fixed to the platen assembly 132 such that a new or unused area of the polishing pad can be released from the supply assembly 156. The polishing pad 123 can be releasably fixed by a vacuum pressure applied to a lower surface of the polishing pad, by use of mechanical clamps, or by other holding methods to the platen assembly 132. The platen assembly 132 contains and protects the components necessary to run the CMP process on the substrate 122.

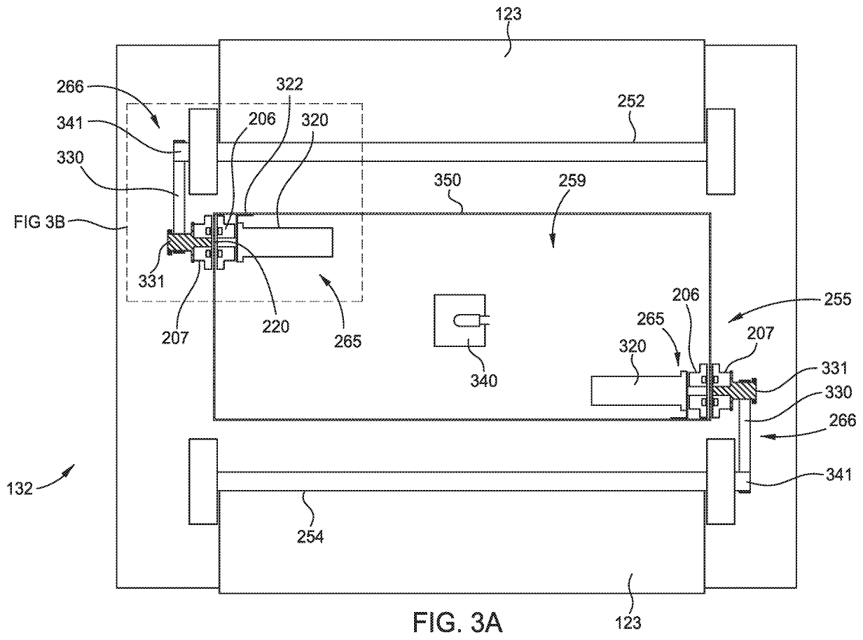

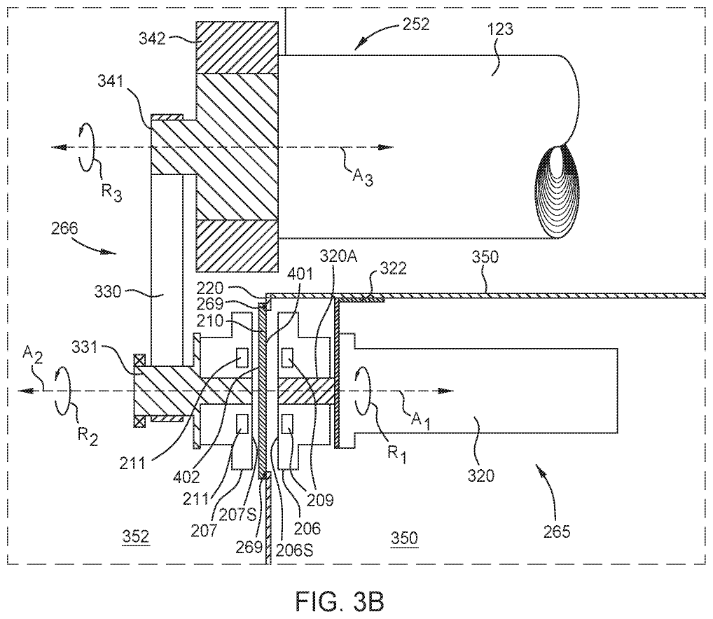

The platen assembly 132 includes the pad supporting surface 240 that supports the polishing pad 123 for use in polishing a substrate 122. The pad supporting surface 240 is recessed within the web assembly 256 to form or at least partially define a recessed region 261 over which the polishing pad 123 is disposed. The polishing pad 123 can be advanced (e.g., indexed) relative to the alternate or modified version of the platen assembly 132 before and/or after removing material from one or more substrates 122 by use of a hub rotation assembly 265 (FIG. 3A) of the hub assembly 255 and a web rotation assembly 266 (FIG. 3A) of the web assembly 256. The polishing pad 123 is pulled taught over the rounded edges 214, 204.

In another embodiment, the polishing pad 123 is a traditional chemical mechanical polishing pad that is placed into the recessed region 261. The polishing process can utilize a slurry containing abrasive particles delivered to the surface of the polishing pad 123 by fluid nozzles 154 (FIG. 1A) to aid in polishing the substrate 122. Alternatively, the fluid nozzles 154 can deliver de-ionized water (DIW) alone, or in combination with polishing chemicals. The fluid nozzles 154 can rotate in the direction shown to a position clear of the platen assembly 132 as shown, to a position over each of platen assemblies. The fluid nozzles 154 can track with the sweeping motion of the carrier head 152 so the slurry is deposited adjacent to the carrier head 152 and towards the pad supporting surface 240.

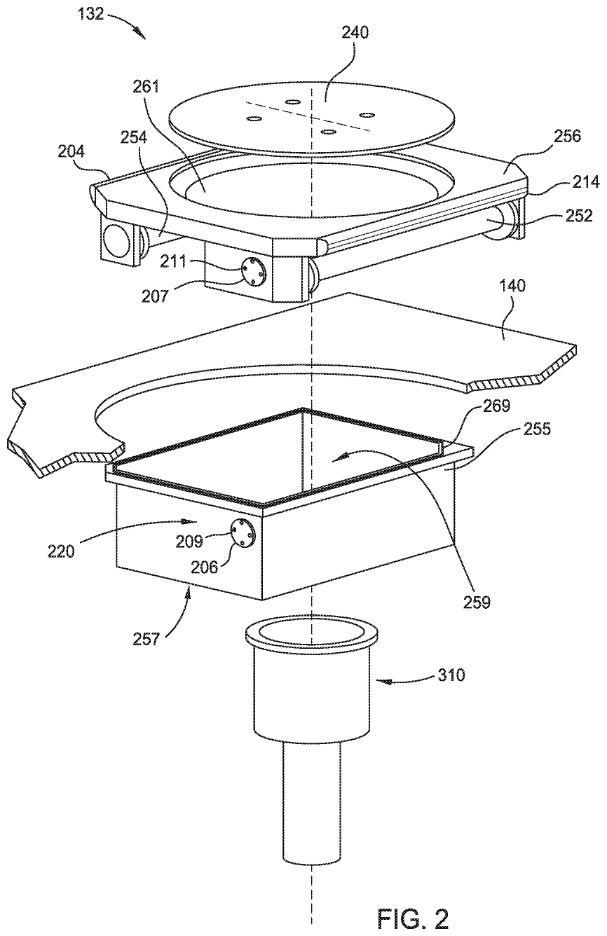

FIG. 2 illustrates an exploded view of the platen assembly 132 in which the polishing pad 123 is not shown for clarity of illustration, according to one embodiment. FIGS. 3A and 3B are bottom views of the platen assembly 132 illustrated in FIGS. 1A-B and 2. The web assembly 256 and hub assembly 255 are separable from each other, and can also be rotated together by use of a second actuator 310. The second actuator 310 rotates the entire platen assembly 132 about its vertical axis (Z-axis), providing the polishing for the substrate 122 held by the carrier head 152.

As shown in FIGS. 2 and 3A-3B, the platen assembly 132 includes a coupling apparatus 257. The coupling apparatus 257 that includes a first coupling member 206 and a second coupling member 207 that are coupled to, and adapted to, drive the first spindle 252 or the second spindle 254 to advance the polishing pad 123 across the pad supporting surface 240. In some embodiments, the first coupling member 206 is contiguous with the hub assembly 255, and the second coupling member 207 is contiguous with the web assembly 256. As further discussed below in conjunction with FIGS. 3A-3B, the first coupling member 206 has a first coupling surface 206S, and the first coupling surface is located a distance from a first surface 401 of a wall 220 of an interface plate 210, where the wall is part of the side wall of the web assembly 256, according to one embodiment. The second coupling member 207 has a second coupling surface 207S, located a distance from a second surface 402 of the wall 220, on the opposite side of the wall 220 from the first surface of the first coupling member 206. The coupling apparatus 257 is thus used to form a sealed polishing pad 123 advancement system, as described below.

Referring to FIGS 3A and 3B, the first coupling member 206 is coupled to the second coupling member 207 through the wall 220. In one embodiment, the wall 220 is a side wall of the hub assembly 255. In one embodiment, the first coupling member 206 and the second coupling member 207 are magnetic couplings that are positioned on either side of a non-ferromagnetic or a non-ferrimagnetic material containing wall 220 (FIG. 2) of the hub assembly 255. The first coupling member 206 and the second coupling member 207 are magnetically coupled through the wall 220

The first coupling member 206 includes a first plurality of magnets 209 that are positioned in a first orientation relative to a first surface 401 of the wall 220, and the second coupling member 207 includes a second plurality of magnets 211 that are positioned in a second orientation relative to a second surface 402 of the wall, the first plurality of magnets have a first pole facing the first surface of the wall and the second plurality of magnets have a second pole facing the second surface of the wall, and the second pole and the first pole are opposite poles of a magnet, according to some embodiments. The first plurality of magnets 209 present a north magnetic pole, and the second plurality of magnets 211 present a south magnetic pole, according to one embodiment. This provides an attractive coupling between the first plurality of magnets 209 and the second plurality of magnets 211 when the north and south poles in the first coupling member 206 are aligned with the corresponding south and north poles in the second coupling member. The first plurality of magnets 209 has a different magnetic field strength than the second plurality of magnets 211, according to one embodiment.

The magnetic field coupling designs described herein help to at least seal the components in the hub assembly 255 to protect the first actuator 320 and optical end point 340 (FIG. 3A) from the often harsh chemical environment caused by the slurry and other chemicals used during polishing of a substrate 122 on a surface of the polishing pad 123. In addition, any slurry that does reach the exterior surface of the wall 220 will generally not affect the magnetic coupling between the first coupling member 206 and the second coupling member 207. In one embodiment, the wall 220 surrounds and isolates the first coupling member 206, and its supporting components, from the second coupling member 207, which further protects at least the first coupling member from a harsh chemical environment. The coupling apparatus 257 holds the web assembly 256 and the hub assembly 255 together.

In one embodiment, the wall 220 is one solid piece. However, manufacturing constraints sometimes provide for a wall 220 with a hole, and the hole is covered by an interface plate 210, according to one embodiment. The first coupling member 206 makes a seal with the interface plate 210, and the second coupling member 207 makes a seal with the interface plate, according to one embodiment. The seal can be vacuum tight, gas tight or preferably at least liquid tight, so as to protect the apparatus components disposed within the interior region 259 of the hub assembly 255 from harsh chemicals outside, along with moisture and other liquids from the CMP process. The seal 269 can be supplied by an o-ring or another sealing member between either the first coupling member 206 and the wall 220 or the second coupling member 207 and the wall 220. The o-ring can be made of nitrile, silicone, neoprene, ethylene propylene, or any other elastomer or rubber. The seal can be supplied by a mechanical fastener, such as a set of screws, bolts, or the like. The individual components of the web assembly 256 and the hub assembly 255 are described below.

As shown in FIG. 3A, the hub assembly 255 includes two hub rotation assemblies 265 and optionally an optical end point 340. Each of the hub rotation assemblies 265 includes a first coupling member 206 that is coupled to a first actuator 320. In another embodiment of a hub rotation assembly 265, the first coupling member 206 is coupled to the first actuator 320 by a flexible coupling. The web assembly 256 includes two web rotation assemblies 266, a pad supporting surface 240, edges 214,204, a first spindle 252 and a second spindle 254. Each of the web rotation assemblies 266 include a second coupling member 207 that is coupled to a pulley 331 that is coupled to the first spindle 252 or the second spindle 254 by use of a pulley 341 and belt 330.

The optical end point 340 is positioned within the walls 220, and is used to monitor the status of the polishing, according to one embodiment. The optical end point 340 can be positioned to view and inspect a surface of a substrate 122 during polishing by use of a sensor (not shown) that is positioned to view the surface of the substrate through an opening formed in one or more of the components used to support the pad supporting surface 240 of the web assembly 256.

As discussed above, the web assembly 256 also includes a pad supporting surface 240, and edges 214, 204. The pad supporting surface 240 provides support for the polishing pad 123 during processing. The polishing pad 123 moves across the rounded edges 214, 204 and is pulled taught by use of the hub rotation assembly 265 and hub rotation assembly 265 which is coupled to the first spindle 252 and another hub rotation assembly 265 and hub rotation assembly 265 which is coupled to the second spindle 254. In one embodiment, the pad supporting surface 240 is itself separable from the remainder of the web assembly 256, which further decreases the cost and time if only the pad supporting surface needs maintenance or repair. The web assembly 256 provides a support for the polishing pad 123, and provides the rotational motion necessary to move unexposed portions of the polishing pad 123 for further polishing. The description of the rotation to move the polishing pad 123 is given below.

FIG. 3B illustrates a zoomed-in below view of a portion of the platen assembly 132 of FIG. 1B, according to one embodiment. In one configuration, the first actuator 320 of the hub rotation assembly 265 is bolted to the wall 220 by use of an actuator brace 322. The first actuator 320 is directly bolted to the hub assembly sidewall 350, according to one embodiment. During processing, the first actuator 320 of the hub rotation assembly 265 causes the first coupling member 206 of the hub rotation assembly 265 to rotate, which in turn causes the second coupling member 207 of the web rotation assembly 266 to rotate due to the coupling of the first coupling member 206 to the second coupling member 207. In this example, the first actuator 320 rotates in a first direction R₁ about first axis A₁, which in turn provides rotation through the actuator coupling 320A to the first coupling member 206. Therefore, due to the coupling of the first coupling member 206 to the second coupling member 207, the second coupling member 207 rotates in a direction R₂ about a second axis A₂. The first axis A₁ can lie parallel to the second axis A₂, or at any arbitrary angle to A₂. The rotation of the second coupling member 207 causes the belt 330 and pulley 341 in the web rotation assembly 266 to rotate, which causes spindles 252, 254 to rotate, and thus causes a portion of the polishing pad 123 disposed on spindles 252, 254 to be “let out” or “taken up” depending on the direction that the spindles 252, 254 are rotated. Therefore, in this example, the belt 330 and pulley 341 cause the first spindle 252 to rotate in a third direction R₃ about third axis A₃. The polishing pad 123 is wrapped around the first spindle 252, and the rotation of the first spindle pulls the polishing pad across the pad supporting surface 240. The first spindle 252 is attached to the web assembly sidewall 352 via a spindle bolt 342.

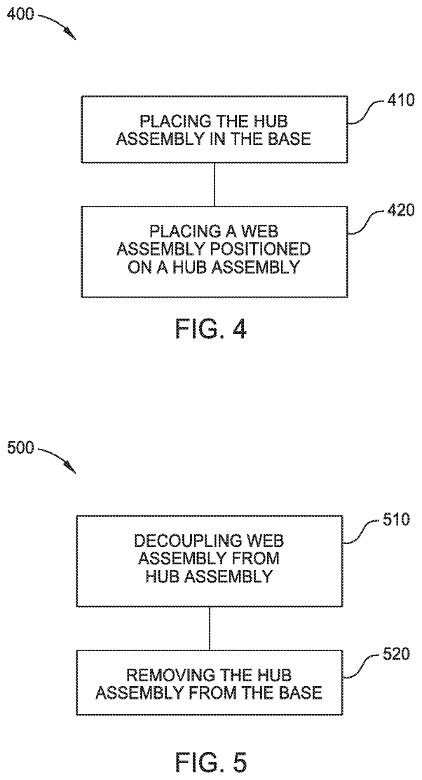

FIG. 4 is a flow diagram of method 400 operations for positioning and coupling the web assembly 256 on a hub assembly 255, according to one embodiment. Although the method operations are described in conjunction with FIG. 4, persons skilled in the art will understand that any module configured to perform the method operations, in any order, falls within the scope of the embodiments described herein.

The method begins at operation 410, where the hub assembly 255 is placed such that the first coupling member 206 of the hub rotation assembly 265 is separated by a distance from the first surface 401 of the wall 220.

At operation 420, the web assembly 256 is placed on the hub assembly 255 such that the second coupling member 207 of the web rotation assembly 266 is disposed a distance from the second surface 402 of the wall 220, such that the second surface is on an opposite side of the wall from the first surface 401, and the first coupling member 206 is coupled to the second coupling member 207. The second coupling member 207 allows a rotational motion imparted to the second coupling member 207 from the first coupling member 206 to cause a rotational motion of the first spindle 252 and movement of at least a portion of the polishing pad 123. The first coupling member 206 and the second coupling member 207 are magnetic couplings, according to one embodiment. The placing a web assembly 256 on a hub assembly 255 results in an assembled platen assembly 132. In some embodiments, the weight of the web assembly 256 against the seal 269 (FIG. 2) positioned between the hub assembly 255 causes a seal to be formed which prevents fluids from passing from a region in which the web rotation assembly 266 resides (e.g., external region) into a region in which the hub rotation assembly 265 resides (i.e., internal region). The seal 269 can be an o-ring. The o-ring can be made of nitrile, silicone, neoprene, ethylene propylene, or any other elastomer or rubber.

FIG. 5 is a flow diagram of method 500 operations for decoupling a web assembly 256 from a hub assembly 255, according to one embodiment. Although the method operations are described in conjunction with FIG. 5, persons skilled in the art will understand that any module configured to perform the method operations, in any order, falls within the scope of the embodiments described herein.

The method begins at operation 510, where the hub assembly 255 is removed from the web assembly 256 such that the second coupling member 207 is no longer separated by a distance from the second surface 402 of the wall 220. Alternately, during operation 510, the hub assembly 255 is decoupled such that the first coupling member 206 is disposed a distance from the first surface 401 of the wall 220.

In some embodiments, decoupling includes pulling apart the first coupling member 206 and the second coupling member 207 with enough force such that the magnetic coupling is broken between these two components. Pulling the first coupling member 206 and the second coupling member 207 apart with enough force such that the magnetic coupling is broken can include moving the second coupling member in a direction that is parallel to the wall 220, according to one embodiment. The decoupling the web assembly 256 from a hub assembly 255 results in a disassembled platen assembly 132.

At operation 520, the hub assembly 255 is removed from the base 140.

As described above, the web assembly and the hub assembly are separable. The assemblies couple together through the first coupling member and the second coupling member, and the coupling is a magnetic coupling. The web assembly and hub assembly are placed or decoupled via the methods as described above.

The ability to place the web assembly onto the hub assembly, without needing to remove the entire platen assembly, shortens repair time and labor costs. The magnetic coupling between the first coupling member and the second coupling member allows for a fluid tight seal to be formed that protects at least the components inside the hub assembly from the harsh chemical environment. The magnetic coupling between the first coupling member and the second coupling member allows for the rotation of the coupling members in unison, while still forming a fluid tight seal between the web assembly and the hub assembly.

While the foregoing is directed to implementations of the present invention, other and further implementations of the invention may be devised without departing from the basic scope thereof, and the scope thereof is determined by the claims that follow.

1. A coupling apparatus, comprising:
a first coupling member having a first coupling surface, wherein the first coupling surface is disposed a distance from a first surface of a wall;
a second coupling member having a second coupling surface, wherein the second coupling surface is disposed a distance from a second surface of the wall and the second surface is on an opposite side of the wall from the first surface; and
a first spindle that is configured to support a length of a polishing pad material and is coupled to the second coupling member, wherein the second coupling member allows a rotational motion imparted to the second coupling member from the first coupling member to cause a second rotational motion of the first spindle.

2. The coupling apparatus of claim 1, wherein
the first coupling member comprises a first plurality of magnets that are positioned in a first orientation relative to the first surface of the wall,
the second coupling member comprises a second plurality of magnets that are positioned in a second orientation relative to the second surface of the wall, and
the first plurality of magnets have a first pole facing the first surface and the second plurality of magnets have a second pole facing the second surface, and the second pole and the first pole are opposite poles of a magnet.

3. The coupling apparatus of claim 2, wherein
the first pole comprises a north magnetic pole, and
the second pole comprises a south magnetic pole.

4. The coupling apparatus of claim 1, wherein the wall further comprises:
an interface plate that is positioned over an opening formed within a portion of the wall; and
a first seal that is disposed between the interface plate and the first coupling member, and a second seal that is disposed between the interface plate and the second coupling member.

5. A platen assembly, comprising:
a wall;
a hub assembly, comprising:
a first coupling member having a first coupling surface, wherein the first coupling surface is disposed a distance from a first surface of the wall; and
a first actuator coupled to the first coupling member; and
a web assembly positioned on the hub assembly, wherein the web assembly comprises:
a pad supporting surface;
a second coupling member having a second coupling surface, wherein the second coupling surface is disposed a distance from a second surface of the wall and the second surface is on an opposite side of the wall from the first surface; and
a first spindle that is coupled to the second coupling member, wherein the second coupling member allows a rotational motion imparted to the second coupling member from the first coupling member to cause a first rotational motion of the first spindle.

6. The platen assembly of claim 5, wherein the web assembly is separable from the hub assembly.

7. The platen assembly of claim 5, wherein the portion of the polishing pad comprises a length of a polish pad that is disposed on a roll.

8. The platen assembly of claim 7, wherein the polish pad is configured to be advanced by a supply assembly and a take-up assembly.

9. The platen assembly of claim 5, wherein
the first coupling member comprises a first plurality of magnets that are positioned in a first orientation relative to the first surface of the wall,
the second coupling member comprises a second plurality of magnets that are positioned in a second orientation relative to the second surface of the wall, and
the first plurality of magnets have a first pole facing the first surface and the second plurality of magnets have a second pole facing the second surface, and the second pole and the first pole are opposite poles of a magnet.

10. The platen assembly of claim 8, wherein
the first pole comprises a north magnetic pole, and
the second pole comprises a south magnetic pole.

11. The platen assembly of claim 5, wherein the wall further comprises:
an interface plate that is positioned over an opening formed within a portion of the wall; and
a first seal that is disposed between the interface plate and the first coupling member, and a second seal that is disposed between the interface plate and the second coupling member.

12. The platen assembly of claim 5, wherein the wall surrounds and isolates the first coupling member from the second coupling member.

13. A method of assembling a platen assembly, comprising:
placing a web assembly on a hub assembly, wherein the web assembly comprises:
a pad supporting surface;
a second coupling member having a second coupling surface, wherein the second coupling surface is disposed a distance from a wall; and
a first spindle that is configured to support a length of a polishing pad material and is coupled to the second coupling member, the first spindle configured to rotationally support a roll of pad material;
and the hub assembly comprises:
a first coupling member having a first coupling surface, wherein the first coupling surface is disposed a distance from a first surface of the wall;
a first actuator coupled to the first coupling member; and
wherein the second coupling surface is on an opposite side of the wall from the first surface, and the first coupling member and the second coupling member are coupled together through the wall, and the second coupling member allows a rotational motion imparted to the second coupling member from the first coupling member to cause a first rotational motion of the first spindle.

14. The method of claim 13, further comprising placing the hub assembly, wherein the first coupling surface is disposed a distance from the first surface of the wall.

15. The method of claim 13, wherein
the first coupling member comprises a first plurality of magnets that are positioned in a first orientation relative to the first surface of the wall,
the second coupling member comprises a second plurality of magnets that are positioned in a second orientation relative to the second coupling surface of the wall, and
the first plurality of magnets have a first pole facing the first surface and the second plurality of magnets have a second pole facing the second coupling surface, and the second pole and the first pole are opposite poles of a magnet.

16. The method of claim 15, wherein
the first pole comprises a north magnetic pole, and
the second pole comprises a south magnetic pole.

17. The method of claim 16, wherein the first plurality of magnets has a different magnetic field strength than the second plurality of magnets.

18. The method of claim 17, wherein the portion of the polishing pad material comprises a length of a polish pad that is disposed on a roll.

19. The method of claim 13, wherein the wall further comprises:
an interface plate that is positioned over an opening formed within a portion of the wall; and
a first seal that is disposed between the interface plate and the first coupling member, and a second seal that is disposed between the interface plate and the second coupling member.

20. The method of claim 19, wherein the wall surrounds and isolates the first coupling member from the second coupling member.
